(19) United States
(12) Patent Application Publication
(10) Pub. No.: US 2023/0086517 A1
(43) Pub. Date: Mar. 23, 2023

(54) SYSTEM FOR FABRICATING EXTRUDED DRIPPER

(71) Applicant: N-Drip Ltd., Kfar Saba (IL)

(72) Inventors: Zvi MILLER, Kiryat-Tivon (IL); Uri SHANI, Tel-Aviv (IL); Sharon DABACH, Tel-Aviv (IL)

(73) Assignee: N-Drip Ltd., Kfar Saba (IL)

(21) Appl. No.: 17/792,161

(22) PCT Filed: Dec. 8, 2021
(86) PCT No.: PCT/IL2021/051460

§ 371 Date: Jul. 12, 2022

Related U.S. Application Data
(60) Provisional application No. 63/122,492, filed on Dec. 8, 2020.

(51) Int. Cl. B23P 19/04; B29C 48/00; B29C 48/06

(52) U.S. Cl. CPC B23P 19/04; B29C 48/0022; B29C 48/06; A01G 25/023

(57) ABSTRACT

A system for fabricating an irrigation dripper, comprises several processing stations. One or more longitudinal drilling stations drill in an elongated extruded body of an irrigation dripper a first bore and a second bore, wherein the second bore is contiguous to the first bore and is smaller in diameter than the first bore. An additional drilling station drills an additional bore in the body to connect the first bore with an external surface of the elongated body. An assembling station inserts an extruded rod through the first and the second bores, such that the second bore holds a distal end of the rod to maintain a gap between the rod and an inner wall of the first bore.

### RELATED APPLICATION

This application claims the benefit of priority of U.S. Provisional Patent Application No. 63/122,492 filed on 8 Dec. 2020, the contents of which are incorporated herein by reference in their entirety.

### FIELD AND BACKGROUND OF THE INVENTION

The present invention, in some embodiments thereof, relates to irrigation drippers and, more particularly, but not exclusively, to a system for fabricating extruded irrigation dripper.

Drip irrigation is a watering method that utilizes pressurized water sources and drips water along a distribution pipe in a controlled manner. Drip irrigation systems are considered to be more efficient than surface irrigation systems that typically distribute water in the fields by runoff. Surface irrigation systems require smaller investment and lower energy costs, and these systems typically employ high discharge at the inlet in order to irrigate efficiently and uniformly across a field so that water will reach the end of the field.

In drip irrigation system, drippers are inserted into or mounted onto a water supply line typically at regular intervals. Examples of drippers for drip irrigation system are described in International publication Nos. WO2017/191640 and WO2019/092717, the contents of which are hereby incorporated by reference. These publications describe a dripper with a pathway that is not one-dimensional and that allows bypass routes around obstacles that may be inside the dripper.

Several techniques have been heretofore suggested for using extrusion to make drippers. U.S. Pat. No. 9,877,442 discloses a method of manufacturing a drip line by extruding a first tube layer, embossing inlets and pressure-reducing flow channels on an exterior surface of the first tube layer, extruding a second tube layer over the first tube layer to enclose the inlets and flow channels, and making outlet openings in the second extruded tube layer. U.S. Pat. No. 5,732,887 discloses a method of making a drip irrigation tape. A strip of polyethylene material is first extruded from an extruder and a channel is then formed in the first side edge portion of the strip by passing it between a shaping drum and an opposing guide drum. A folding mechanism folds the strip with its opposite side edges overlapping. A heat-sealing station forms seal lines to seal the overlapping edges together.

Additional background art includes U.S. Pat. No. 4,330,497 which discloses a method of making grooved tubing having a groove in the outer sidewall and a hole through the bottom of the groove by extrusion.

### SUMMARY OF THE INVENTION

According to some embodiments of the invention the present invention there is provided a system for fabricating an irrigation dripper. The system comprises: at least one longitudinal drilling station for drilling in an elongated extruded body of an irrigation dripper a first bore along a longitudinal direction, and a second bore, contiguous to the first bore and being smaller in diameter than the first bore. The system also comprises at least one additional drilling station configured for drilling an additional bore in the body to connect the first bore with an external surface of the elongated body, and an assembling station configured for inserting an extruded rod through the first and the second bores, such that the second bore holds a distal end of the rod to maintain a gap between the rod and an inner wall of the first bore.

According to some embodiments of the invention symmetry axes of the first bore and the second bores are collinear.

According to some embodiments of the invention the at least one longitudinal drilling station comprises a driller having a drill bit having a first segment for drilling the first bore, and a second segment contiguous to the first segment, for drilling the second bore.

According to some embodiments of the invention symmetry axes of the first bore and the second bores are offset with respect to each other.

According to some embodiments of the invention the system comprises a conveyor system for serial conveyance of elongated bodies among the stations.

According to some embodiments of the invention the at least one longitudinal drilling station is arranged to execute horizontal drilling.

According to some embodiments of the invention the additional drilling station is arranged to execute vertical drilling.

According to some embodiments of the invention the system comprises a bonding station for bonding the distal end to an inner wall of the second bore.

According to some embodiments of the invention the bonding station is configured to perform at least one of gluing, ultrasonic welding, laser welding, electric welding, arc welding, plasma welding, riveting, screwing, and deforming.

According to some embodiments of the invention the system comprises an inspection station configured for imaging the rod following the insertion. According to some embodiments of the invention the inspection station is configured for maintaining the body at an upright orientation.

According to some embodiments of the invention the system comprises a packaging station for arranging the irrigation body in a cartridge, following the insertion of the rod by the assembling station.

According to some embodiments of the invention the system comprises an extruder system for continuous extrusion of a first extrudate through a first die and a second extrudate through a second die, and for repeatedly cutting the first extrudate to form a plurality of elongated bodies to be drilled by the stations and repeatedly cutting the second extrudate to form a plurality of rods to be inserted through the bores.

According to an aspect of some embodiments of the present invention there is provided a method of fabricating an irrigation dripper. The method comprises: drilling in an elongated extruded body of an irrigation dripper, a first bore along a longitudinal direction, and a second bore, contiguous to the first bore and being smaller in diameter than the first bore. The method also comprises drilling an additional bore in the body to connect the first bore with an external surface of the elongated body, and inserting an extruded rod through the first and the second bores, such that the second bore holds a distal end of the rod to maintain a gap between the rod and an inner wall of the first bore.

According to some embodiments of the invention a combined length of the first and the second bores is less than a length of the elongated body.

According to some embodiments of the invention a combined length of the first and the second bores equals a length of the elongated body.

According to some embodiments of the invention the drilling along the longitudinal direction is by a drill bit having a first segment for drilling the first bore, and a second segment contiguous to the first segment, for drilling the second bore.

According to some embodiments of the invention the drilling of the first and the second bores are executed horizontally. According to some embodiments of the invention the drilling of the additional bore is executed vertically.

According to some embodiments of the invention the method comprises welding the distal end to an inner wall of the second bore.

According to some embodiments of the invention the method comprises imaging the rod following the insertion. According to some embodiments of the invention the method comprises the imaging is executed while maintaining the body at an upright orientation.

According to some embodiments of the invention the method comprises automatically arranging the irrigation body in a cartridge, following the insertion of the rod by the assembling station.

According to some embodiments of the invention the method comprises continuously extruding a first extrudate through a first die and a second extrudate through a second die, and repeatedly cutting the first extrudate to form a plurality of elongated bodies to be drilled and repeatedly cutting the second extrudate to form a plurality of rods to be inserted through the bores.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-D illustrate an exemplified irrigation dripper according to some embodiments of the present invention, where FIG. 1A illustrates a cross-sectional view of the irrigation dripper once assembled, FIG. 1B illustrates a cross-sectional view of the irrigation dripper before assembling, and FIGS. 1C-D illustrate perspective view of the irrigation dripper once assembled;

FIGS. 2A-B are schematic illustrations showing a typical use of the irrigation dipper, according to some embodiments of the present invention;

FIGS. 3A-F are schematic illustrations showing a block diagram (FIG. 3A) and a Computer-Aided Design drawings (FIGS. 3B-F) of a system for fabricating an irrigation dripper, according to some embodiments of the present invention;

FIG. 4 is a schematic illustration of an extrusion system configured to extrude rods and bodies for use in the fabrication of an irrigation dripper according to some embodiments of the present invention;

FIG. 5 is a schematic illustration showing a representative example of a driller suitable for horizontal drilling two bores in a single drilling operation, according to some embodiments of the present invention;

FIG. 6 is a Computer-Aided Design drawing of a system for fabricating an irrigation dripper in embodiments in which stations of the system are arranged along a straight path; and

FIG. 7 is a Computer-Aided Design drawing of a system for fabricating an irrigation dripper in embodiments in which the system is configured as a single circle system.

### DESCRIPTION OF SPECIFIC EMBODIMENTS OF THE INVENTION

The present invention, in some embodiments thereof, relates to irrigation drippers and, more particularly, but not exclusively, to a system for fabricating extruded irrigation dripper.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

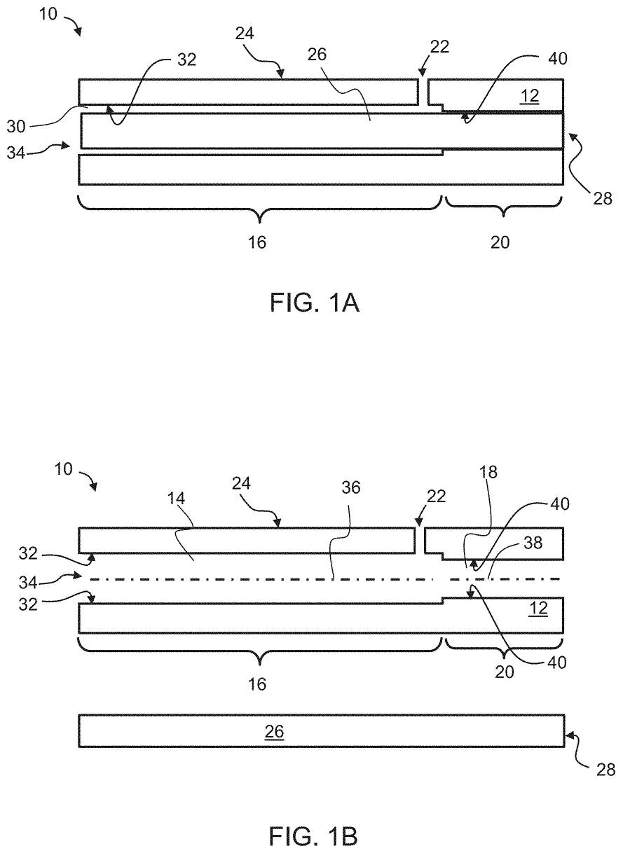

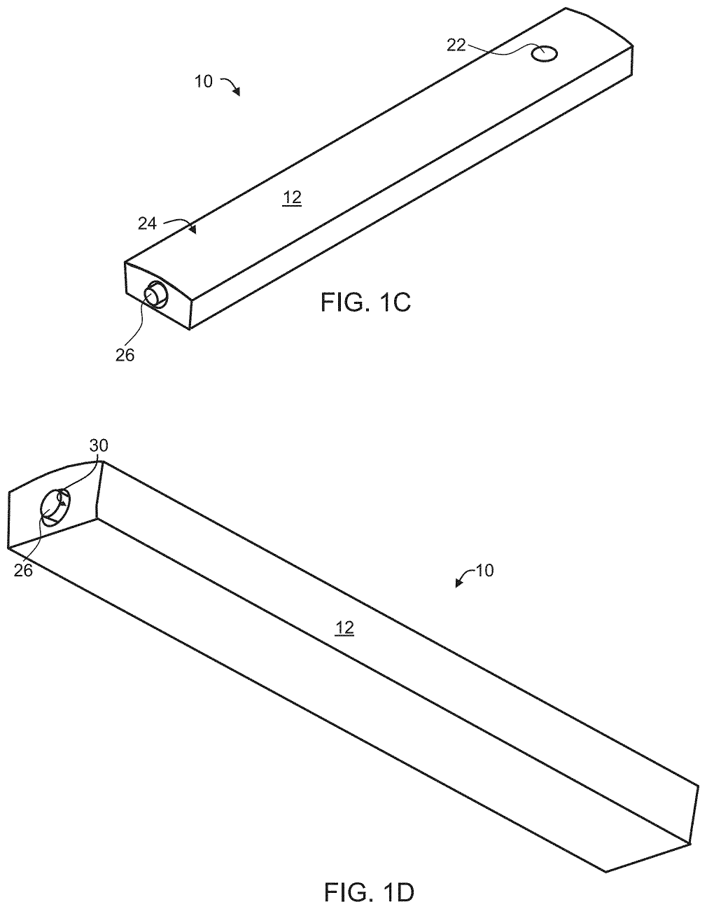

Referring now to the drawings, FIGS. 1A-D illustrate an exemplified irrigation dripper 10 that can be fabricated according to some embodiments of the present invention. FIG. 1A illustrates a cross-sectional view of irrigation dripper 10 once assembled, FIG. 1B illustrates a cross-sectional view of irrigation dripper 10 before assembling, and FIGS. 1C-D illustrate perspective view of irrigation dripper 10 once assembled.

Dripper 10 comprises an elongated body 12, having therein a first longitudinal bore 14 along a first segment 16 of body 12, and a second longitudinal bore 18 along a second segment 20 of body 12, wherein second bore 18 is contiguous to first bore 14 and smaller in diameter than first bore 14.

The term “longitudinal bore”, as used herein, means a bore drilled along a longitudinal direction.

Herein, the longitudinal direction is defined as a direction along the largest dimension of body 12, and the radial direction is defined as a direction perpendicular to the longitudinal direction.

A typical diameter of bore 14 is from about 0.5 mm to about 5.5 mm, e.g., about 2.5 mm.

A typical length of bore 14 is from about 5% to about 95%, more preferably from about 20% to about 95% more preferably from about 40% to about 95% more preferably from about 60% to about 95% more preferably from about 80% to about 95% of the length of elongated body 12.

A typical diameter of bore 18 is from about 0.3 mm to about 5 mm, e.g., about 2.4 mm.

A typical length of bore 18 is from about 5% to about 95%, more preferably from about 5% to about 80% more preferably from about 5% to about 60% more preferably from about 5% to about 40% more preferably from about 5% to about 20% of the length of elongated body 12.

A typical length of elongated body 12 is from about 5 mm to about 65 mm, e.g., about 25 mm.

Elongated body 12 can be a round body with typical diameter from about 3 mm to about 20 mm. Elongated body can be a rectangle with dimensions from about 2×3 mm to about 3×10 mm. Elongated body can be a square shape with dimensions from about 2×2 mm to about 10×10 mm.

The outer surface 24 of body 12 can have any shape, including, without limitation, a cylinder, or a prism (e.g., a triangular prism, a parallelepiped, a square cuboid, a rectangular cuboid etc.). In the schematic illustrations in FIGS. 1C and 1D, which are not to be considered as limiting, body 12 has a shape which resembles a rectangular cuboid, except that its upper faces has a curvature. The bulk of body 12 is optionally and preferably made by continuous extrusion of an extrudate through a die having the desired shape and repeatedly cutting the extrudate to form a plurality of elongated bodies such as body 12.

One or more bores 22 (only one is illustrated in FIGS. 1A-C) are formed in body 12 to connect the outer surface 24 with bore 14. Bore(s) 22 is/are at an angle to the longitudinal direction. In some embodiments of the present invention at least one of bores 22 extends along the radial direction, and is referred to herein as a “radial bore.” One or more of the bores 22 can serve as a water outlet for dripper 10.

A typical diameter of bore 22 is from about 0.5 mm to about 10 mm, more preferably from about 1 mm to about 10 mm.

Irrigation dripper 10 also comprises a rod 26 that, once dripper 10 is assembled, extends along both bores 14 and 18, in a manner that the inner wall 40 of second bore 18 holds a distal end 28 of rod 26 to maintain a gap 30 between rod 26 and an inner wall 32 of first bore 14. Rod 26 can have any shape, including, without limitation, a cylinder, or a prism (e.g., a triangular prism, a parallelepiped, a square cuboid, a rectangular cuboid etc.). In the schematic illustrations in FIGS. 1C and 1D, which are not to be considered as limiting, rod 26 has a cylindrical shape. Rod 26 is optionally and preferably made by continuous extrusion of an extrudate through a die having the desired shape and repeatedly cutting the extrudate to form a plurality of rods such as rod 26.

A typical length of rod 26 is from about 50% to about 120% of the length of body 12.

A typical diameter of rod 26 is from about 50% to about 95% of the diameter of bore 14, and from about 90% to about 99.99% of the diameter of bore 18.

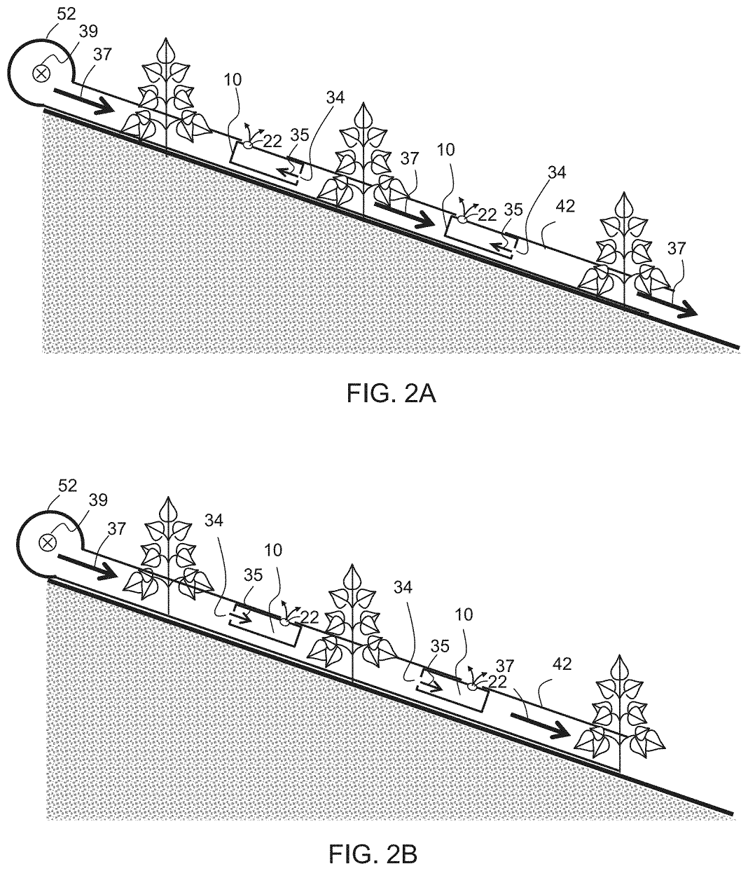

A typical use of dippers 10 is schematically illustrated in FIGS. 2A and 2B. In use, one or more of dippers 10 are introduced into an irrigation dripping pipe 42. The dripping pipe 42 is deployed in a field 34 and a liquid 37 (e.g., water) is introduced into the pipe 42. The liquid enters the dipper 10 through the proximal end 34 of the gap 30 between bore 14 and rod 26 (see FIG. 1A) and drips out of dripper 10 via one or more of bores 22.

Liquid 37 is typically introduced from a distributing line 52 (aligned in FIGS. 2A and 2B perpendicular to the plane of the drawing) or directly from a liquid source (not shown). The flow 39 of liquid in distributing line 52 is illustrated as circled crosses which represent a direction into the plane of the drawings. FIG. 2A illustrates a preferred embodiment in which the proximal end 34 is downstream with respect to the flow 37 outside the dripper, so that the inflow 35 of liquid (e.g., water) through proximal end 34 is opposite to the flow 37 in pipe 42 outside the dripper. In experiments performed by the Inventors it was unexpectedly discovered that such a construction provides a more efficient dripping with less clogging, and significantly reduces the maintenance effort required to maintain dripping. Yet, configurations in which the proximal end 34 is upstream with respect to the flow outside the dripper (namely irrigation dripping pipes in which the inflow into the dripper is generally along the direction of the flow in the pipe outside the dripper) are also contemplated, and are illustrated in FIG. 2B.

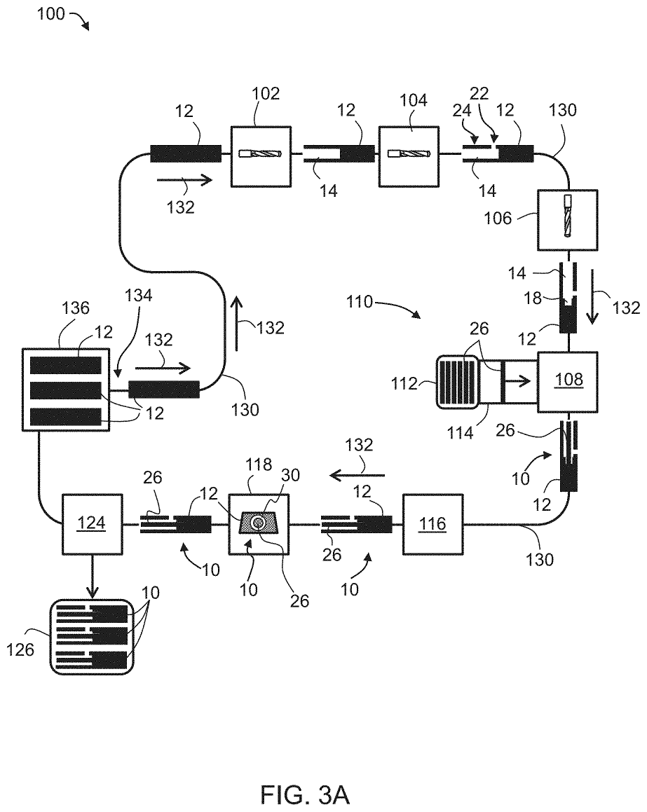

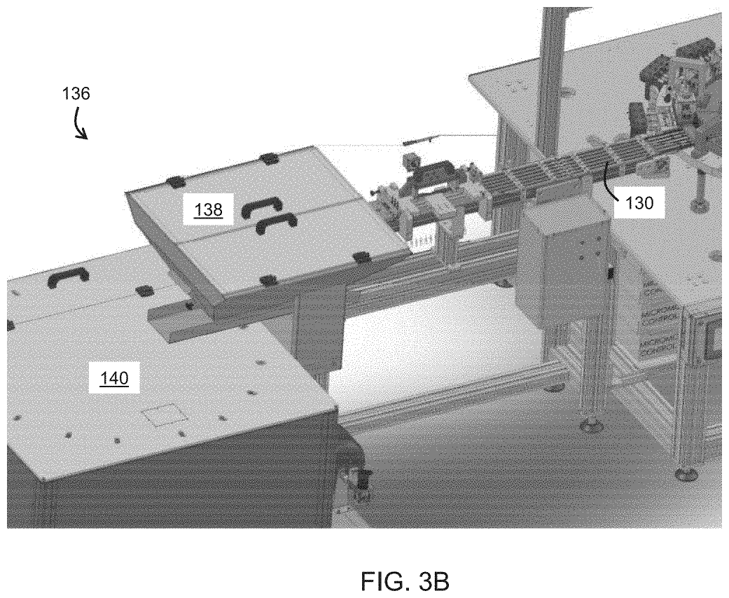

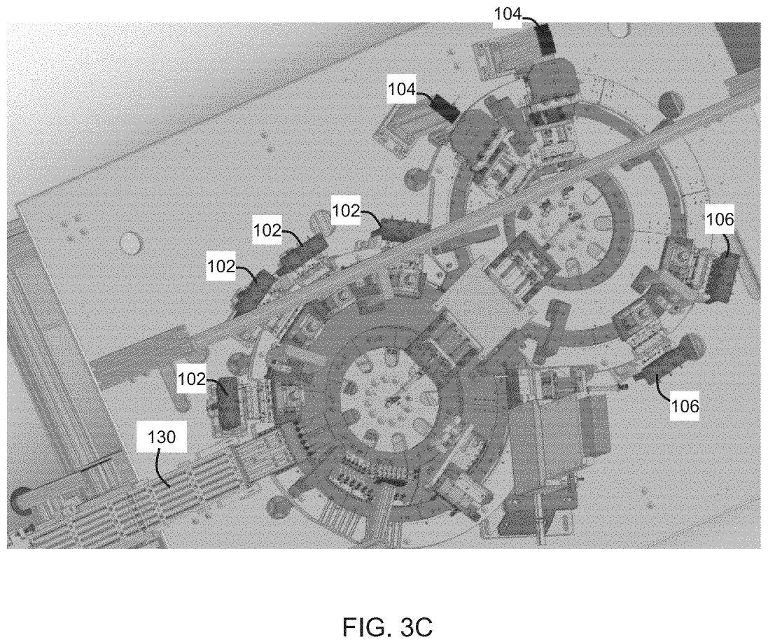

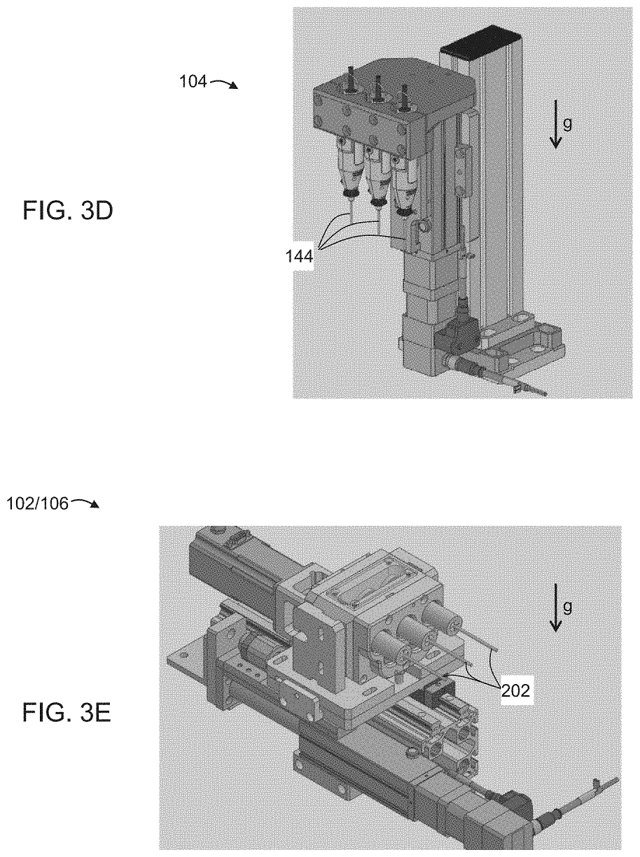

Reference is now made to FIGS. 3A-F which are schematic illustrations showing a block diagram (FIG. 3A) and a Computer-Aided Design drawings (FIGS. 3B-F) of a system 100 for fabricating irrigation dripper 10, according to some embodiments of the present invention. System 100 comprises at least one longitudinal-drilling station 102, 106, configured for receiving body 12 and automatically drilling the first 14 and the second 18 bores along the longitudinal direction in segments 16 and 20 of body 12. While FIG. 3A illustrates two separate stations 102, 106 for the longitudinal drilling of bores 14 and 18, this need not necessarily be the case, since, for some applications, both bores 14 and 18, can be drilled in the same station, as further detailed hereinbelow.

When bores 14 and 18 are drilled in separate stations, drilling station 106 is configured for drilling in body 12 second bore 18, contiguous to first bore 14 and being smaller in diameter than first bore 14. The length along the longitudinal direction of bore 18 is optionally and preferably less than the length along the longitudinal direction of bore 14. Drilling stations 102 and 106 can be configured to drill bores 14 and 18 such that the symmetry axis 36 of bore 14 and the symmetry axis 38 of bore 18 are collinear. Alternatively, the symmetry axes 36 and 38 can be offset with respect to each other.

The length along the longitudinal direction of bore 14 is less than the length along the longitudinal direction of body 12. Preferably, but not necessarily, at least one of drilling stations 102, 106 is arranged to execute horizontal drilling. In this embodiment, body 12 enters the station in a horizontal orientation and is being drilled horizontally at the station while maintaining its horizontal orientation.

As used herein, “horizontal drilling” refers to a drilling operation in which the drill bit is oriented perpendicularly to the gravity.

As used herein, “horizontal orientation” refers to an orientation of an object (e.g., body 12) in which the largest dimension of the object is perpendicularly to the gravity. As used herein, “vertical drilling” refers to a drilling operation in which the drill bit is oriented parallel to the gravity.

As used herein, “vertical orientation” refers to an orientation of an object (e.g., body 12) in which the largest dimension of the object is parallel to the gravity.

FIG. 3E schematically exemplify embodiments in which drilling station 102 or 106 is arranged to execute horizontal drilling, and in which the drill bit or bits 202 are oriented perpendicular to the gravity g. In the schematic illustration of FIG. 3E, stations 102/106 are shown as having a plurality of bits 202, thus allowing the station to drill the longitudinal bores in more than one body 12, if desired.

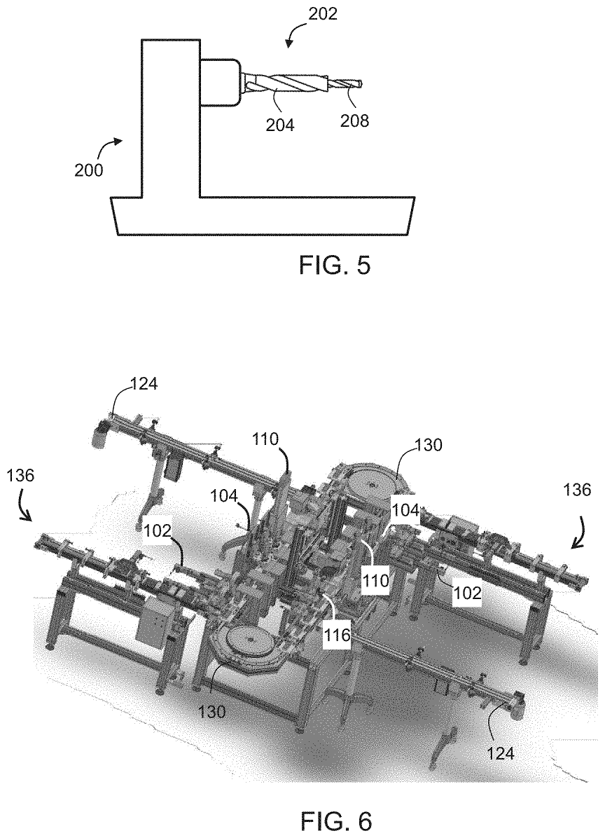

When bores 14 and 18 are drilled in the same longitudinal-drilling station (e.g., in drilling station 102), the drilling station can employ a driller configured for drilling both bores in a single drilling operation. A representative example of a driller 200 suitable for these embodiments is illustrated in FIG. 5. In these embodiments the drill bit 202 that is mounted on driller 200 comprises a first segment 204 for drilling first bore 14, and a second segment 208, contiguous to first segment 204, for drilling second bore 18. The two segments are of different diameters, wherein the segment 208 that is farther from driller 200 is smaller in diameter than the segment 204 that is proximal to driller 200. In some embodiments of the present invention the two segments are of different lengths with the segment 208 that is farther from driller 200 is smaller in length than the segment 204 that is proximal to driller 200. Use of a longitudinal-drilling station having a drill bit with two segments of different diameters, is particularly useful for fabricating an irrigation dripper in which symmetry axes 36 and 38 are collinear.

In some embodiments of the present invention drilling station 102 is configured to drill bore 14 at a generally central location with respect to the outer surface 24 of body 12. When the outer surface has an irregular shape, the location of the symmetry axis 36 of bore 14 within body 12 is optionally and preferably selected by station 102 such as to minimize the variability of the shortest distances between the symmetry axis 36 and the outer surface of body 12.

System 100 also comprises an additional drilling station 104 configured for receiving body 12 and automatically drilling a bore 22 at an angle to the longitudinal direction, to connect bore 14 with external surface of body 12. For example, drilling station 104 can drill a radial bore by drilling along the radial direction. Preferably, but not necessarily, drilling station 104 is arranged to execute vertical drilling, with the drill bit or bits 144 oriented parallel to the gravity g, as exemplified in FIG. 3D. In the schematic illustration of FIG. 3D, station 104 is shows as having a plurality of bits 144, thus allowing station 104 to drill more than one radial bore 22 in body 12, if desired. Each of the radial bores 22 can serve as a water outlet of the irrigation dripper, or, one or more of the radial bores 22 can have other functions, such as to assist flow. In this embodiment, body 12 enters station 104 in a horizontal orientation and is being drilled vertically at station 104 while maintaining its horizontal orientation.

It is appreciated that system 100 can comprise more than one drilling station for the same purpose, so as to increase the throughput. For example, FIG. 3C illustrates a configuration with four drilling stations 102 for drilling bore 14, two drilling stations 104 for drilling bore 22, and two drilling stations 106 for drilling bore 18. The number of drilling stations 102 is larger since bore 14 is longer than bores 18 and 22 and so more time is typically allocated for the drilling of bore 14 than for the drilling of bores 22 and 18.

In some embodiments of the present invention system 100 comprises an assembling station 108 configured for inserting rod 26 through bores 14 and 18, thus forming irrigation dripper 10. The insertion is such that bore 18 holds distal end 28 of rod 26 to maintain gap 30 between rod 26 and inner wall 32 of bore 14 (not shown, see FIGS. 1A and 1B). Rod 26 can be supplied to assembling station 108 by a rod supplying system 110, which may include a magazine 112 holding a plurality of rods 26 positioned in the vicinity of station 108 and a feeder 114 configured to serially supply the rods to station 108. Feeder 114 can be of any type known in the art, such as, but not limited to, a bowl feeder (e.g., a vibratory bowl feeder or a centrifugal bowl feeder), a step feeder, and the like.

It is expected that during the life of a patent maturing from this application many relevant feeders will be developed and the scope of the term feeder is intended to include all such new technologies a priori.

System 100 can optionally and preferably also comprises a bonding station 116 for bonding the distal end 28 of rod 26 to the inner wall 40 (see FIGS. 1A and 1B) of bore 26. The bonding can be according to any technique known in the art, including, without limitation, ultrasonic welding, laser welding, electric welding, arc welding, plasma welding, gluing, riveting, screwing, deforming, and the like. In the schematic illustration of FIG. 3F, station 116 is configured for welding the distal end of the rod to the inner wall of the second bore, but any of the above alternative techniques for bonding is also contemplated, according to some embodiments of the present invention. In some embodiments of the present invention boding station 116 is combined with assembling station 108, in which case rod 26 is bonded to the inner wall 40 immediately upon insertion into bore 18.

In some embodiments of the present invention system 100 comprises an inspection station 118 at which the fabricated irrigation dripper 10 can be inspected, for quality control. The inspection is optionally and preferably, but not necessarily, from above, in which case inspection station 118 maintains body 12 at an upright orientation, as schematically illustrated in the block diagram of FIG. 3A. This can be achieved by a lever system 120 (see FIG. 3F) configured for rotating body 12 from its horizontal orientation upon entry to station 118 to an upright orientation. Alternatively, the inspection can be executed while body 12 assumes a horizontal orientation In some embodiments of the present invention inspection station 118 comprises a camera 122 (see FIG. 3F) for imaging rod 26 following its insertion through bores 14 and 18. Camera 122 is preferably positioned such that the optical axis of camera 122 is collinear with between the symmetry axis 36. When the inspection is from above, camera 122 is positioned such that its field-of-view is vertical, and when the inspection is horizontal camera 122 is positioned so that its field-of-view is horizontal. Quality control can then be performed, for example, by a computer (not shown) applying an image processing procedure for processing images generated by camera 122. For example, the computer can be configured to inspect the existence of gap 30 and alert when the gap is missing or when the width of the gap is improper.

System 100 optionally and preferably comprises a packaging station 124 for arranging the irrigation dripper 10, once assembled, in a cartridge 126. Typically, station 124 arranges several hundreds of irrigation drippers in cartridge 126.

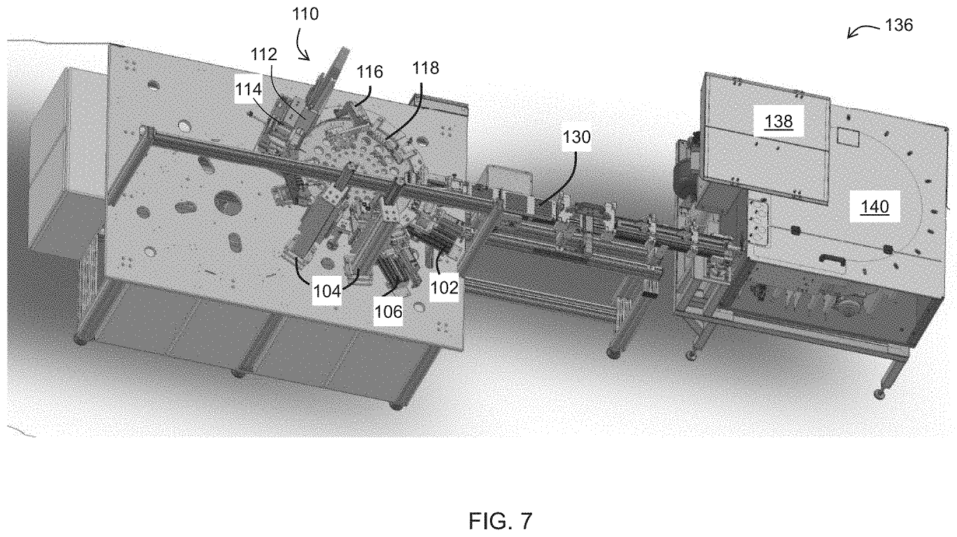

The conveyance of body 12 among the stations of system 100 is typically achieved by means of a conveyor system 130, which may be in the form of a belt, a chain, an arrangement of rollers, or any combination thereof. Conveyor system 130 is deployed for serially conveying body 12 in the direction of arrows 132, from an entry point 134, through stations 102, 104, 106, 108, 116, 118, and to packaging station 124, which, when employed, enacts the exit point off conveyor system 130. While, the block diagram of FIG. 3A illustrates conveyor system 130 as conveying bodies 12 one by one, this need not necessarily be the case, since, for some applications, it may be desired to serially convey groups of dripper bodies, e.g., to serially convey pairs, triples, quads or more dripper bodies together such that for at least one station, more than one dripper body enter the station, and are processed by the station, simultaneously. FIGS. 3B, 3C and 3F illustrate an embodiment in which conveyor system 130 is arranged to convey the dripper bodies in groups of six. The system illustrated in FIGS. 3F and 3C employs 2 circles for the fabrication process, but it can also be configured as a single circle system, as schematically exemplified in FIG. 7. Further, the stations in the system illustrated in FIGS. 3A, 3F and 3C are arranged along a round path, but they can also be arranged along a straight path, as schematically exemplified in FIG. 6, or a path which combines round and straight portions.

A plurality of dripper bodies 12 can be serially supplied to conveyor system 130 at entry point 134 by means of a dripper body supplying system 136. Supplying system 136 can include a magazine 138 holding a plurality of rods bodies 12 and a feeder 140 (FIG. 3B) configured to serially supply the elongated bodies 12 to conveyor system 130. Feeder 140 can be of any type known in the art, such as, but not limited to, a bowl feeder (e.g., a vibratory bowl feeder or a centrifugal bowl feeder), a step feeder, and the like. Magazine 138 is typically loaded with elongated bodies that have already been extruded and cut at a different location.

The magazines 112 (holding the rods) and 138 (holding the elongated bodies) are each typically loaded with the rods and elongated bodies after they have been extruded and cut at a different location.

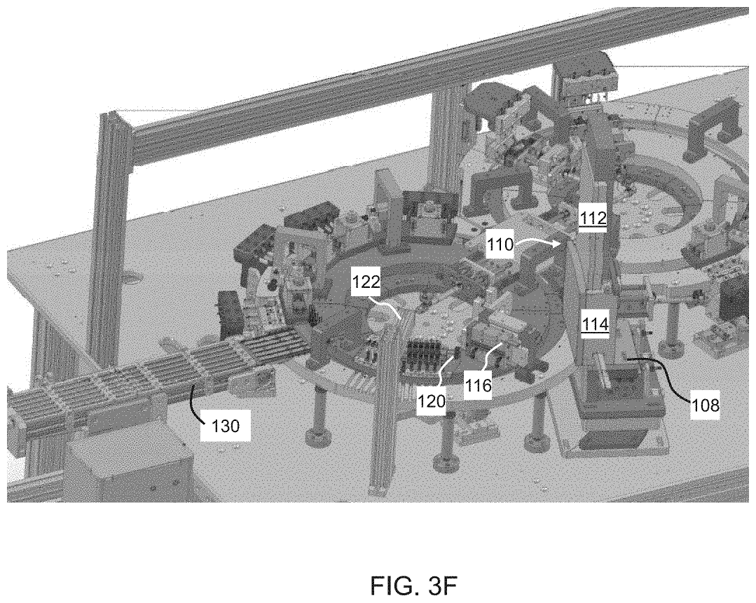

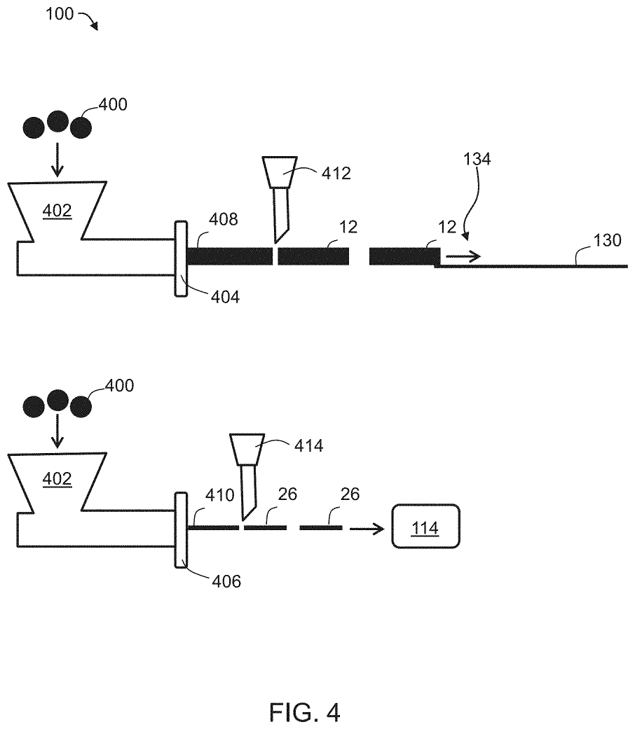

The present embodiments also contemplate embodiments in which system 100 also extrudes the rods 26 and bodies 12 and delivers them to the conveyor system 130. These embodiments are schematically illustrated in FIG. 4.

Raw material 400 is fed to an extruder 402, which can be of any known type, such as, but not limited to, a single or multiple-screw extruder.

Raw material 400 can be any type of material suitable for extrusion. Preferably, material 400 is characterized by a Melt Flow Index (MFI) value of from about 0.01 g/10 min to about 30 g/10 min, as determined by MFI measuring protocol and equipment under the ISO 1133-1:2011 standard. A representative examples for material suitable for use as material 400 includes, without limitation, a polyethylene, e.g., linear low density polyethylene (LLDPE), low density polyethylene (LDPE), medium density polyethylene (MDPE), high density polyethylene (HDPE), ultra high molecular weight polyethylene (UHMWPE), high molecular weight polyethylene (HMWPE), high density cross-linked polyethylene (HDXLPE), cross-linked polyethylene (PEX), very low density polyethylene (VLDPE), and the like. The chemical and physical properties of polyethylene are disclosed in Andrew Peacock, “Handbook of Polyethylene: Structures, Properties, and Applications,” Marcel Dekker, Inc., New York (2000), the contents of which are hereby incorporated by reference. Additional examples for a material suitable for use as material 400 including, without limitation, polypropylene, polystyrene, poly-1-butene, and poly-4-methyl-1-pentene, acetal, acrylic, polyamide, polyvinyl chloride (PVC), acrylonitrile butadiene styrene (ABS), polycarbonate, and the like.

It is expected that during the life of a patent maturing from this application many relevant extruders and raw materials suitable for extrusion will be developed and the scopes of the terms “extruder” and “raw material” are intended to include all such new technologies a priori.

The raw material 400 is melted in the extruder 402, and the molten raw material is forced by the extruder 402 through dies 404, 406, respectively shaped according to the desired shape of the outer surfaces of the elongated bodies 12 and the rods 26. For clarity of presentation, the dies 404 and 406 are shown as receiving the melted material from different extruders. However, this need not necessarily be the case, since, for some applications, it may be desired to arrange dies 404, 406 to receive the raw material from the same extruder. These embodiments are particularly useful when body 12 and rod 26 are made of the same material.

The resulting extrudates 408, 410 are repeatedly cut by cutting members 412, 414 to form a plurality of elongated bodies 12 and a plurality of rods 26. The bodies 12 can be loaded, optionally directly after cutting, to the conveyor system 130 at entry point 134. Alternatively, the bodies 12 can be loaded, optionally directly after cutting, to the magazine 138, which can later be loaded to dripper body supplying system 136. The rods 26 can be loaded, optionally directly after cutting, to the feeder of rod supplying system 110. Alternatively, the rods 26 can be loaded, optionally directly after cutting, to the magazine 112, which can later be loaded to rod supplying system 110.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A system for fabricating an irrigation dripper, comprising:
at least one longitudinal drilling station for drilling in an elongated extruded body of an irrigation dripper, a first bore along a longitudinal direction, and a second bore, contiguous to said first bore and being smaller in diameter than said first bore;
at least one additional drilling station configured for drilling an additional bore in said body to connect said first bore with an external surface of said elongated body; and
an assembling station configured for inserting an extruded rod through said first and said second bores, such that said second bore holds a distal end of said rod to maintain a gap between said rod and an inner wall of said first bore;
wherein a combined length of said first and said second bores is less than a length of said elongated body.

2-3. (canceled)

4. The system according to claim 1, wherein symmetry axes of said first bore and said second bores are collinear.

5-7. (canceled)

8. The system according to claim 1, wherein symmetry axes of said first bore and said second bores are offset with respect to each other.

9. (canceled)

10. The system according to claim 1, comprising a conveyor system for serial conveyance of elongated bodies among said stations.

11. (canceled)

12. The system according to claim 1, wherein said at least one longitudinal drilling station is arranged to execute horizontal drilling.

13. (canceled)

14. The system according to claim 1, wherein said additional drilling station is arranged to execute vertical drilling.

15. (canceled)

16. The system according to claim 1, comprising a bonding station for bonding said distal end to an inner wall of said second bore.

17-19. (canceled)

20. The system according to claim 1, comprising an inspection station configured for maintaining said body at an upright orientation, and imaging said rod following said insertion.

21. (canceled)

22. The system according to claim 1, comprising a packaging station for arranging said irrigation body in a cartridge, following said insertion of said rod by said assembling station.

23. (canceled)

24. The system according to claim 1, comprising an extruder system for continuous extrusion of a first extrudate through a first die and a second extrudate through a second die, and for repeatedly cutting said first extrudate to form a plurality of elongated bodies to be drilled by said stations and repeatedly cutting said second extrudate to form a plurality of rods to be inserted through said bores.

25. (canceled)

26. A method of fabricating an irrigation dripper, comprising:
drilling in an elongated extruded body of an irrigation dripper, a first bore along a longitudinal direction, and a second bore, contiguous to said first bore and being smaller in diameter than said first bore;
drilling an additional bore in said body to connect said first bore with an external surface of said elongated body; and
inserting an extruded rod through said first and said second bores, such that said second bore holds a distal end of said rod to maintain a gap between said rod and an inner wall of said first bore;
wherein a combined length of said first and said second bores equals a length of said elongated body.

27-28. (canceled)

29. The method according to claim 26, wherein symmetry axes of said first bore and said second bores are collinear.

30-32. (canceled)

33. The method according to claim 26, wherein symmetry axes of said first bore and said second bores are offset with respect to each other.

34. (canceled)

35. The method according to claim 26, wherein said drilling of said first and said second bores are executed horizontally.

36. (canceled)

37. The method according to claim 26, wherein said drilling of said additional bore is executed vertically.

38. (canceled)

39. The method according to claim 26, comprising welding said distal end to an inner wall of said second bore.

40. (canceled)

41. The method according to claim 26, comprising imaging said rod following said insertion while maintaining said body at an upright orientation.

42. (canceled)

43. The method according to claim 26, comprising automatically arranging said irrigation body in a cartridge, following said insertion of said rod by said assembling station.

44. (canceled)

45. The method according to claim 26, comprising continuously extruding a first extrudate through a first die and a second extrudate through a second die, and repeatedly cutting said first extrudate to form a plurality of elongated bodies to be drilled and repeatedly cutting said second extrudate to form a plurality of rods to be inserted through said bores.

46. (canceled)

47. A system for fabricating an irrigation dripper, comprising:
at least one longitudinal drilling station for drilling in an elongated extruded body of an irrigation dripper, a first bore along a longitudinal direction, and a second bore, contiguous to said first bore and being smaller in diameter than said first bore;
at least one additional drilling station configured for drilling an additional bore in said body to connect said first bore with an external surface of said elongated body;
an assembling station configured for inserting an extruded rod through said first and said second bores, such that said second bore holds a distal end of said rod to maintain a gap between said rod and an inner wall of said first bore; and
an extruder system for continuous extrusion of a first extrudate through a first die and a second extrudate through a second die, and for repeatedly cutting said first extrudate to form a plurality of elongated bodies to be drilled by said stations and repeatedly cutting said second extrudate to form a plurality of rods to be inserted through said bores.
